(19) United States
(12) Patent Application Publication
(10) Pub. No.: US 2021/0017195 A1
(43) Pub. Date: Jan. 21, 2021

(54) PROCESS FOR FUNCTIONALIZATION OF ORGANO-ZINC COMPOUNDS WITH HALOSILANES USING BASIC NITROGEN CONTAINING HETEROCYCLES AND SILYL-FUNCTIONALIZED COMPOUNDS PREPARED THEREBY

(71) Applicants: Dow Global Technologies LLC, Midland, MI (US); Dow Silicones Corporation, Midland, MI (US)

(72) Inventors: Jordan Reddel, Midland, MI (US); Robert David Grigg, Midland, MI (US); Phillip Dene Hustad, St. Paul, MN (US); Sukrit Mukhopadhyay, Midland, MI (US); Steven Swier, Midland, MI (US); Ken Kawamoto, Midland, MI (US)

(21) Appl. No.: 16/982,490

(22) PCT Filed: Mar. 18, 2019
(86) PCT No.: PCT/US2019/022790

§ 371 Date: Sep. 18, 2020

Related U.S. Application Data
(60) Provisional application No. 62/644,635, filed on Mar. 19, 2018.

(51) Int. Cl. C07F 3/06; C08F 2/38; C08F 8/22; C08F 8/42

(52) U.S. Cl. CPC C07F 3/06; C08F 2/38; C08F 8/22; C08F 2810/40; C08F 2410/01; C08F 2800/10; C08F 2800/20; C08F 8/42

(57) ABSTRACT

A process to functionalize organo-zinc compounds with halosilane electrophiles employs a basic additive. The process includes combining the organo-zinc compound, a halosilanes, and a nitrogen containing heterocycle as the basic additive. The presence of the basic additive facilitates successful substitution. Functionalized silanes and silyl-terminated polyolefins can be prepared using this process. The functionalized silanes may be useful as endblockers for polyorganosiloxanes having SiH and/or silicon bonded aliphatically unsaturated groups capable of undergoing hydrosilylation.

### CROSS-REFERENCE TO RELATED APPLICATIONS

The present application claims the benefit of U.S. provisional patent application No. 62/644,635, filed on Mar. 19, 2018, which is hereby incorporated by reference in its entirety.

### TECHNICAL FIELD

A process to functionalize organo-zinc compounds with halosilane electrophiles employs a basic additive. The organo-zinc compound, a nitrogen containing heterocycle as the basic additive, and a halosilane are combined at elevated temperature. The presence of the basic additive facilitates successful substitution.

### BACKGROUND

Olefin block copolymers can be derived from polymeryl-zinc species generated in chain-shuttling polymerizations. However, organo-zinc reagents are generally not nucleophilic enough to react with chlorosilane electrophiles. More active silyl electrophiles such as iodosilanes and silyl triflates might demonstrate improved reactivity in some cases; however, the cost of these reagents is significantly greater than the chlorosilane counterparts. And, iodosilanes may still not react completely with the organozinc reagents.

### SUMMARY OF THE INVENTION

A process for preparing a silyl functionalized compound comprises combining starting materials comprising:

A) an organo-zinc compound,

B) a nitrogen containing heterocycle, and

C) a halosilane;

thereby forming a product comprising a silyl functionalized compound. The silyl functionalized compound may be a silyl-terminated polyolefin or a hydrocarbylsilane.

### DETAILED DESCRIPTION OF THE INVENTION

The silyl functionalized compound may be a silyl-terminated polyolefin, when A) the organo-metal compound is a polymeryl-zinc, such a polyolefin-zinc. The silyl-terminated polyolefin can be prepared by a process comprising:

1) combining starting materials comprising

A) the polymeryl-zinc;

B) the nitrogen containing heterocycle, and

C) the halosilane;

thereby forming a product comprising the silyl-terminated polyolefin.

The process may optionally further comprise one or more additional steps selected from:

2) washing the product with water, and
3) recovering the product.

The process may optionally further comprise: forming the polymeryl-zinc before step 1) by a process comprising combining starting materials comprising

i) an olefin monomer,

ii) a catalyst, and

iii) a chain shuttling agent of formula R₂Zn, where each R is independently a hydrocarbyl group of 2 to 12 carbon atoms; thereby forming a solution or slurry containing the polymeryl-zinc.

The process may optionally further comprise: purifying the polymeryl-zinc before step 1). Purifying may be performed by any convenient means such as: filtration and/or washing with a hydrocarbon solvent. Alternatively, the solution or slurry prepared as described above may be used to deliver starting material A), i.e., the slurry may be combined with starting materials comprising B) the nitrogen containing hererocycle and C) the halosilane in step 1) of the process described above.

### A) Polymeryl-Zinc

Starting material A) used in the process described above may be a polymeryl-zinc. The polymeryl-zinc may be prepared by a process comprising combining starting materials comprising

i) an olefin monomer,

ii) a catalyst, and

iii) a chain shuttling agent of formula R₂Zn, where each R is independently a hydrocarbyl group of 2 to 30 carbon atoms. The polymeryl-zinc may be prepared using known process conditions and equipment, such as those disclosed in U.S. Pat. No. 7,858,706 to Arriola, et al. at col. 52, line 2 to col. 57, line 21 and U.S. Pat. No. 8,053,529 to Carnahan, et al.

Examples of suitable olefin monomers include straight chain or branched alpha-olefins of 2 to 30 carbon atoms, alternatively 2 to 20 carbon atoms, such as ethylene, propylene, 1-butene, 3-methyl- 1-butene, 1-pentene, 1-hexene, 4-methyl-1-pentene, 3-methyl-1-pentene, 1-octene, 1-decene, 1-dodecene, 1-tetradecene, 1-hexadecene, 1-octadecene, and 1-eicosene; cycloolefins of 3 to 30, alternatively 3 to 20 carbon atoms such as cyclopentene, cycloheptene, norbornene, 5-methyl-2-norbornene, tetracyclododecene, and 2-methyl-1,4,5,8-dimethano-1,2,3,4,4a,5,8,8a-octahydronaphthalene. Suitable olefin monomers are disclosed for example, at col. 16, lines 5-36 of U.S. Pat. No. 7,858,706 and at col. 12, lines 7 to 41 of U.S. Pat. No. 8,053,529, which are hereby incorporated by reference. Alternatively, starting material i) may comprise ethylene and optionally one or more olefin monomers other than ethylene, such as propylene or 1-octene. Alternatively, the olefin monomer may be ethylene and 1-octene. Alternatively, the olefin monomer may be ethylene.

Suitable catalysts include any compound or combination of compounds that is adapted for preparing polymers of the desired composition or type. One or more catalysts may be used. For example, first and second olefin polymerization catalysts may be used for preparing polymers differing in chemical or physical properties. Both heterogeneous and homogeneous catalysts may be employed. Examples of heterogeneous catalysts include Ziegler-Natta compositions, especially Group 4 metal halides supported on Group 2 metal halides or mixed halides and alkoxides and chromium or vanadium based catalysts. Alternatively, for ease of use and for production of narrow molecular weight polymer segments in solution, the catalysts may be homogeneous catalysts comprising an organometallic compound or metal complex, such as compounds or complexes based on metals selected from Groups 3 to 15 or the Lanthanide series of the Periodic Table of the Elements. Starting material ii) may further comprise a cocatalyst in addition to the catalyst. The cocatalyst may be a cation forming co-catalyst, a strong Lewis Acid, or combination thereof. Suitable catalysts and cocatalysts are disclosed, for example, at col. 19, line 45 to col. 51, line 29 of U.S. Pat. No. 7,858,706, and col. 16, line 37 to col. 48, line 17 of U.S. Pat. No. 8,053,529, which are hereby incorporated by reference. Suitable procatalysts that may also be added include but are not limited to those disclosed in PCT Publications WO 2005/090426, WO 2005/090427, WO 2007/035485, WO 2009/012215, WO 2014/105411, WO 2017/173080, U.S. Patent Publication Nos. 2006/0199930, 2007/0167578, 2008/0311812, and U.S. Pat. Nos. 7,355,089 B2, 8,058,373 B2, and 8,785,554 B2.

The chain shuttling agent used to prepare the polymeryl-zinc has formula R₂Zn, where each R is independently a hydrocarbyl group of 1 to 20 carbon atoms. The hydrocarbyl group for R has 1 to 20 carbon atoms, alternatively 2 to 12 carbon atoms. The hydrocarbyl group may be an alkyl group, which may be linear or branched. R may be an alkyl group exemplified by ethyl, propyl, octyl, and combinations thereof. Suitable chain shuttling agents include dialkyl zinc compounds, such as diethylzinc. Suitable chain shuttling agents are disclosed at col. 16, line 37 to col. 19, line 44 of U.S. Pat. No. 7,858,706 and col. 12, line 49 to col. 14, line 40 of U.S. Pat. No. 8,053,529, which are hereby incorporated by reference.

The starting materials for preparing the polymeryl-zinc may optionally further comprise one or more additional starting materials selected from: iv) a solvent, vi) a scavenger, vii) an adjuvant, and viii) a polymerization aid. Toluene and Isopar™ E are examples of solvents for starting material iv). Isopar™ E is an isoparaffin fluid, typically containing less than 1 ppm benzene and less than 1 ppm sulfur, which is commercially available from ExxonMobil Chemical Company. The process conditions for preparing the polymeryl-zinc are known in the art and are disclosed, for example in U.S. Pat. Nos. 7,858,706, and 8,053,529 at col. 48, which are hereby incorporated by reference.

The polymeryl-zinc prepared as described above may be, for example, A1) di-polyethylene zinc, A2) poly(ethylene/octene) zinc, and mixtures of A1) and A2). Alternatively, the polymeryl-zinc may be di-polyethylene zinc.

### B) Nitrogen Containing Heterocycle

Starting material B) is a nitrogen containing heterocycle. The nitrogen containing heterocycle may be monocyclic. The nitrogen containing heterocycle may have a saturated, partially unsaturated, or aromatic ring. The nitrogen containing heterocycle may have a general formula selected from the group consisting of:

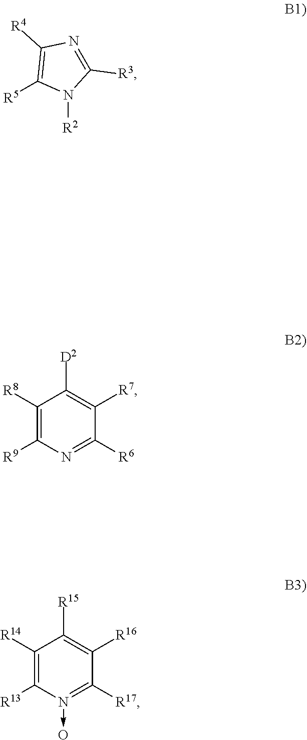

or two or more of B1), B2) and B3), where R² is a monovalent hydrocarbyl group, R³ is a hydrogen atom or a monovalent hydrocarbyl group, R⁴ is a hydrogen atom or a monovalent hydrocarbyl group, R⁵ is a hydrogen atom or a monovalent hydrocarbyl group, R⁶ is a hydrogen atom or a monovalent hydrocarbyl group, R⁷ is a hydrogen atom or a monovalent hydrocarbyl group, R⁸ is a hydrogen atom or a monovalent hydrocarbyl group, R⁹ is a hydrogen atom or a monovalent hydrocarbyl group, and D² is an amino functional hydrocarbyl group or group of formula —NR¹¹₂, where each R¹¹ is a monovalent hydrocarbyl group, R¹³ is a hydrogen atom or a monovalent hydrocarbyl group, R¹⁴ is a hydrogen atom or a monovalent hydrocarbyl group, R¹⁵ is a hydrogen atom or a monovalent hydrocarbyl group, R¹⁶ is a hydrogen atom or a monovalent hydrocarbyl group, and R¹⁷ is a hydrogen atom or a monovalent hydrocarbyl group. Suitable hydrocarbyl groups for R² to R¹⁷ may have 1 to 12 carbon atoms, alternatively 1 to 8 carbon atoms, alternatively 1 to 4 carbon atoms, and alternatively 1 to 2 carbon atoms. Alternatively, the hydrocarbyl groups for R² to R¹⁷ may be alkyl groups. The alkyl groups are exemplified by methyl, ethyl, propyl (including branched and linear isomers thereof), butyl (including branched and linear isomers thereof), and hexyl; alternatively methyl. Alternatively, each R³ to R¹⁰ may be selected from the group consisting of hydrogen and methyl. Alternatively, each R¹³ to R¹⁷ may be hydrogen.

The nitrogen containing heterocycle used as the basic additive in the process described herein may be selected from the group consisting of:

### B4)

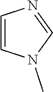

N-methyl imidazole (NMI), B5)

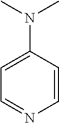

4-(dimethylamino) pyridine (DMAP),

### B6)

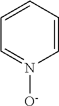

pyridine N-oxide, B7)

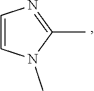

and mixtures of two or more of B4), B5), B6), and B7).

The nitrogen containing heterocycle is added after formation of the polymeryl-zinc.

The amount of starting material B) used in the process described herein depends on various factors including the selection of starting material A) the selection of halosilane for starting material C), however, the amount of starting material B) may be 1 molar equivalent to 100 molar equivalents, based on the amount of starting material C), the halosilanes. The amounts of the starting materials are sufficient to provide at least two molar equivalents of starting material B) and two molar equivalents of starting material C), per molar equivalent of starting material A). Alternatively, a molar excess of starting material B) may be used, e.g., 2.4 molar equivalents of starting material B) per molar equivalent of starting material A). Alternatively, the amounts of the starting materials may be sufficient to provide at least 3 molar equivalents of starting material B) and 3 molar equivalents of starting material C), per molar equivalent of starting material A).

### C) Halosilane

The halosilane suitable for use in the process described herein may have formula R¹ₐSiX₍₄₋ₐ₎, where each R¹ is independently selected from hydrogen and a monovalent hydrocarbyl group of 1 to 18 carbon atoms, each X is independently a halogen atom, and subscript a is 1 to 3. Alternatively, each R¹ may be independently selected from hydrogen, alkyl, alkenyl, and aryl. Alternatively, each R¹ may be independently selected from hydrogen, alkyl, and aryl. Alternatively, each R¹ may be independently selected from hydrogen and aryl. Alternatively, each R¹ may be independently selected from alkyl and aryl. Alternatively, each R¹ may be independently selected from hydrogen and alkyl. Alternatively, at least one R¹ per molecule may be hydrogen. Alternatively, each X may be independently selected from chlorine and iodine. Alternatively, each X may be chlorine. Alternatively, subscript a may be 2 or 3. Alternatively, subscript a may be 2. Alternatively, subscript a may be 3.

Examples of suitable halosilanes include, but are not limited to: dihalosilanes such as dimethyldichlorosilane, methylhydrogendichlorosilane, methylvinyldichlorosilane, dimethyldibromosilane, methylhydrogendiiodosilane, methylvinyldiiodosilane, methylphenyldichlorosilane, methylphenyldibromosilane, methylphenyldiiodosilane, methylhydrogenchloroiodosilane, dimethylchloroiodosilane, methylvinylchloroiodosilane, methylphenylchloroiodosilane, diethyldichlorosilane, ethylhydrogendichlorosilane, ethylvinyldichlorosilane, diethyldibromosilane, ethylhydrogendibromosilane, ethylviniyldibromosilane, diethyldiiodosilane, ethylhydrogendiiodosilane, ethylvinyldiiodosilane, ethylphenyldichlorosilane, ethylphenyldibromosilane, ethylphenyldiiodosilane, ethylhydrogenchloroiodosilane, diethylchloroiodosilane, ethylvinylchloroiodosilane, ethylphenylchloroiodosilane, dipropyldichlorosilane, propylhydrogendichlorosilane, propylvinyldichlorosilane, dipropyldibromosilane, propylhydrogendibromosilane, propylvinyldibromosilane, dipropyldiiodosilane, propylhydrogendiiodosilane, propylvinyldiiodosilane, propylphenyldichlorosilane, propylphenyldibromosilane, propylphenyldiiodosilane, propylhydrogenchloroiodosilane, dipropylchloroiodosilane, propylvinylchloroiodosilane, propylphenylchloroiodosilane, hexenylmethyldichlorosilane, hexenylmethyldibromosilane, hexenylmethyldiiodosilane, hexenylphenyldichlorosilane, hexenylphenyldibromosilane, hexenylphenyldiiodosilane, hexenylmethylchloroiodosilane, hexenylphenylchloroiodosilane, phenylhydrogendichlorosilane, phenylhydrogendiiodosilane, phenylhydrogendibromosilane, and mixtures thereof.

Examples of suitable halosilanes include, but are not limited to: monohalosilanes such as trimethylchlorosilane, dimethylhydrogenchlorosilane, dimethylvinylchlorosilane, trimethylbromosilane, dimethylhydrogenbromosilane, dimethylvinylbromosilane, trimethyliodosilane, dimethylhydrogeniodosilane, dimethylvinyliodosilane, dimethylphenylchlorosilane, dimethylphenylbromosilane, dimethylphenyliodosilane, triethylchlorosilane, diethylhydrogenchlorosilane, diethylvinylchlorosilane, triethylbromosilane, diethylhydrogenbromosilane, diethylvinylbromosilane, triethyldiiodosilane, diethylhydrogeniodosilane, diethylvinyliodosilane, diethylphenylchlorosilane, diethylphenylbromosilane, diethylphenyliodosilane, tripropylchlorosilane, dipropylhydrogenchlorosilane, dipropylvinylchlorosilane, tripropylbromosilane, dipropylhydrogenbromosilane, dipropylvinylbromosilane, tripropyldiiodosilane, dipropylhydrogeniodosilane, dipropylvinyliodosilane, dipropylphenylchlorosilane, dipropylphenylbromosilane, dipropylphenyliodosilane, hexenyldimethylchlorosilane, hexenyldimethylbromosilane, hexenyldimethyliodosilane, hexenylphenylmethyldichlorosilane, hexenylphenylmethylbromosilane, hexenylphenylmethyliodosilane, phenyldihydrogenchlorosilane, phenyldihydrogeniodosilane, phenyldihydrogenbromosilane, diphenylhydrogenchlorosilane, diphenylhydrogeniodosilane, diphenylhydrogenbromosilane, and mixtures thereof.

Alternatively, C) the halosilane is a chlorosilane, e.g., any of the chlorosilanes listed above. Alternatively, C) the halosilane may be selected from the group consisting of C1) dimethylhydrogenchlorosilane, C2) dimethylvinylchlorosilane, C3) diphenylhydrogenchlorosilane, C4) phenyldihydrogenchlorosilane, C5) phenylhydrogendichlorosilane, C6) dimethylhydrogeniodosilane, and mixtures of two or more of C1), C2), C3), C4), C5), and C6). Alternatively, C) the halosilane may be a chlorosilane with at least one silicon bonded hydrogen atom per molecule. Alternatively, C) the halosilane may be selected from the group consisting of C1) dimethylhydrogenchlorosilane, C3) diphenylhydrogenchlorosilane, C4) phenyldihydrogenchlorosilane, C5) phenylhydrogendichlorosilane, C6) dimethylhydrogeniodosilane, and mixtures of two or more of C1), C3), C4), C5), and C6).

### D) Solvent

Starting material D), a solvent may optionally be used in step 1) of the process described above. The solvent may be a hydrocarbon solvent such as an aromatic solvent or an isoparaffinic hydrocarbon solvent. Suitable solvents include but are not limited to a non-polar aliphatic or aromatic hydrocarbon solvent selected from the group of pentane, hexane, heptane, octane, nonane, decane, undecane, dodecane, cyclopentane, methylcyclopentane, cyclohexane, methylcyclohexane, cycloheptane, cyclooctane, decalin, benzene, toluene, xylene, an isoparaffinic fluid including but not limited to Isopar™ E, Isopar™ G, Isopar™ H, Isopar™ L, Isopar™ M, a dearomatized fluid including but not limited to Exxsol™ D or isomers and mixtures of two or more thereof. Alternatively, the solvent may be toluene and/or Isopar™ E. The amount of solvent added depends on various factors including the type of solvent selected and the process conditions and equipment that will be used, however, the amount of solvent may be sufficient to form a 1 molar solution of A) the polymeryl-metal. Optionally, A) the polymeryl-metal may be dissolved in the solvent before combining starting materials B) and C) with starting material A). The amount of solvent will depend on various factors including the selection of starting materials A), B), and C), however, the amount of solvent may be 65% to 95% based on combined weights of all starting materials used in step 1).

Starting materials A), B) and C) and any optional additional starting materials, as described above, may be combined by any convenient means such as mixing. The starting materials may be heated at a temperature of 90° C. to 120° C. for 30 minutes to 3 hours to form the product comprising the silyl-terminated polyolefin. Heating may be performed under inert, dry conditions.

The silyl-terminated polyolefin prepared using the process and starting materials described above may have formula:

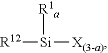

where R¹, X and subscript a are as described above, and R¹² is a hydrogen-terminated polyolefin.

The silyl terminated polyolefin may have unit formula:

H_{f}[(R^{et})ₜ(R^{O})ᵤ]_{g}

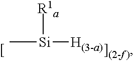

where subscript f is 0 to 1, subscripts t and u have relative values such that 0<t≤1, 0≤u≤1, subscript g is 1 or more, each R^{et} represents an ethylene unit, and each R^{O} represents an olefin unit, other than ethylene. R^{O} may be an alpha-olefin or a cyclic olefin. Examples of alpha-olefins include ethylene, propylene, and octene. Examples of cyclic olefins include ethylidenenorbornene, norbornene, vinyl norbornene, cyclohexene, and cyclopentene.

The silyl terminated polyolefin may have unit formula (A3):

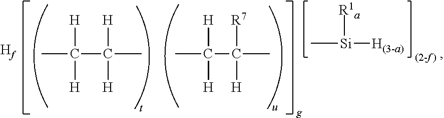

where subscript f is 0 to 1, and subscripts t and u have relative values such that 0<t≤1, 0≤u≤1, subscript g is 1 or more, and each R⁷ is independently a monovalent hydrocarbyl group of 1 to 20 carbon atoms, which is as described and exemplified above for R¹. Alternatively, R⁷ may be an alkyl group of 1 to 12 carbon atoms, and alternatively 1 to 6 carbon atoms. Alternatively, each R⁷ is a hexyl group. Alternatively, subscript g may be 1 to 500, alternatively 10 to 400, and alternatively 18 to 360. Alternatively, subscript g may have a value sufficient to give the silyl terminated polyolefin a Mn of 500 to 50,000 g/mol, alternatively 500 to 10,000 g/mol.

Silyl-terminated polyolefins prepared using the process described above have a silyl group at one end of the polymer chain. Silyl-terminated polyolefins that may be prepared as described herein include silyl-terminated polyethylenes, silyl-terminated polypropylenes, silyl-terminated polybutylenes, silyl-terminated poly (1-butene), silyl-terminated polyisobutene, silyl-terminated poly(l-pentene), silyl-terminated poly(3-methyl-1-pentene), silyl-terminated poly(4-methyl-1-hexene), and silyl-terminated poly(5-methyl-1-hexene). Alternatively, at least one R¹ per molecule is hydrogen, and the silyl-terminated polyolefins prepared using the process described above is a mono-SiH terminated polyolefin. Alternatively, the silyl-terminated polyolefin may be dimethyl,hydrogensilyl-terminated polyethylene; dimethyl,hydrogensilyl-terminated poly(ethylene/octene) copolymer; diphenylhydrogensilyl-terminated polyethylene; diphenylhydrogensilyl-terminated poly(ethylene/octene) copolymer; phenyldihydrogensilyl-terminated polyethylene; phenyldihydrogensilyl-terminated poly(ethylene/octene) copolymer; chlorophenylhydrogensilyl-terminated polyethylene; or chlorophenylhydrogensilyl-terminated poly(ethylene/octene) copolymer.

The product of step 1), which comprises the silyl-terminated polyolefin may be further treated to purify the silyl-terminated polyolefin. Removal of unreacted starting materials and by-products may be performed by any convenient means, such as precipitation of the silyl-terminated polyolefin in a non-solvent, such as methanol, filtration, and water washing.

In an alternative embodiment of the invention, a process for preparing a hydrocarbyl functional silane comprises:

1) combining starting materials comprising

iii) the chain shuttling agent, described above, of formula R₂Zn, where each R is independently a monovalent hydrocarbyl group of 2 to 12 carbon atoms;

B) the nitrogen containing heterocycle, as described above, and

C) the halosilane, as described above;

thereby forming a product comprising the hydrocarbyl functional silane. The starting materials used in this process may optionally further comprise: comprise D) the solvent, as described above. The hydrocarbyl functional silane may have formula:

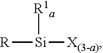

where R, R¹, X and subscript a are as described above. Alternatively, each R may be a monovalent hydrocarbyl group of 1 to 12, carbon atoms, alternatively 2 to 6 carbon atoms.

Starting materials iii), B) and C) and any optional additional starting materials, such as D) the solvent, as described above, may be combined by any convenient means such as mixing. The starting materials may be heated at a temperature of 90° C. to 120° C. for 1 hour to 3 hours to form the product comprising the hydrocarbyl-functional silane. Heating may be performed under inert, dry conditions.

The process for preparing the hydrocarbyl functional silane may optionally further comprise one or more additional steps selected from: precipitation of the hydrocarbyl functional silane in a non-solvent, such as methanol, filtration, and water washing, or distillation.

### EXAMPLES

These examples are intended to illustrate some embodiments of the invention and should not be interpreted as limiting the scope of the invention set forth in the claims.

### Example 1—Alkylation of HMe₂SiCl with Et₂Zn to Form HMe₂SiEt

Samples were prepared by combining 1.0 molar equivalent of dimethylhydrogenchlorosilane (HMe₂SiCl) and 0.5 equivalent of diethyl zinc (Et₂Zn) at RT in the presence of benzene-d6 (C₆D₆) to form a 1 molar solution. In some tests, 10 mol % of a basic additive was added. The % conversion to form dimethyl,hydrogen,ethyl silane was measured by ¹H NMR. The halosilane, additive, and % conversion are reported below in Table 1.

TABLE 1

| Sample | Additive | Conversion (%) |
|---|---|---|
| 1-1 (comparative control) | none | 20 |
| 1-2 (comparative) | CsF | 20 |
| 1-3 (comparative) | TASF | 20 |
| 1-4 (comparative) | TMEDA | 25 |
| 1-5 | DMAP | 85 |
| 1-6 | NMI | 88 |

### Example 2—Alkylation of ViMe₂SiCl with Et₂Zn to Form ViMe₂SiEt

Samples were prepared by combining 1.0 molar equivalent of dimethylvinylchlorosilane (ViMe₂SiCl) and 0.5 equivalent of diethyl zinc (Et₂Zn) at RT in the presence of benzene-d6 (C₆D₆) to form a 1 molar solution. In some tests, a basic additive was added. The % conversion to form alkylated silane product was measured by ¹H NMR. The halosilane, additive, amount of additive and % conversion are reported below in Table 2.

TABLE 2

| | | Amount of | |
|---|---|---|---|
| | | Additive | Conversion |
| Sample | Additive | (mol %) | (mol %) |
| 2-1 (comparative | None | Not applicable | 0 |
| control) | | | |
| 2-2 (comparative) | Lithium | 10 | 0 |
| | iodide (LiI) | | |
| 2-3 (comparative) | LiI | 200 | 0 |
| 2-4 (comparative) | AgNO₃ | 10 | Mixture, |
| | | | decomposition |
| 2-5 (comparative) | CuI | 10 | 0 |
| 2-6 (comparative) | CsF | 50 | 0 |
| 2-7 (comparative) | TASF | 10 | 0 |
| 2-8 (comparative) | TMEDA | 10 | 0 |
| 2-9 | DMAP | 10 | 12 |
| 2-10 | DMAP | 50 | 36 |
| 2-11 | NMI | 50 | 40 |
| 2-12 | NMI | 100 | 74 |

Tables 1 and 2 show that suitable additives to promote silylation of a simple dialkylorganozinc reagent are nitrogen containing heterocycles. Nucleophilic bases such DMAP and NMI promoted the silylation. NMI was particularly successful, and catalytic turnover of the additive was observed with the less-sterically-encumbered dimethylhydrogenchlorosilane. With a more sterically-encumbered electrophile (dimethylvinylchlorosilane), the silylation could be successfully achieved with a higher amount of the additive.

### Example 3—Procedure for Silylation of Di-Polyethylene-Zinc with HMe₂SiCl

Di-polyethylene-zinc and Isopar (M_{w}=1580 Da, 10 mM) were placed in a vial. The vial was heated at 120° C. until the contents became clear and homogeneous. Dimethylhydrogenchlorosilane and NMI were added to the vial. The vial was heated at 90° C. for 3 hours. Iodine (I₂) was then added to quench unreacted di-polyethylene zinc. The resulting product was evaluated by ¹H NMR. The molar equivalents of HMe₂SiCl and conversion to product results are shown below in Table 3.

TABLE 3

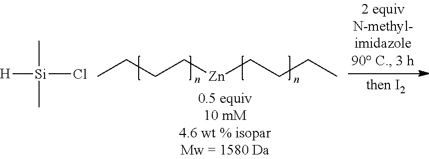

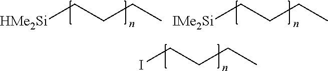

| Entry | Equiv. Si—Cl | Silyl-polymer:Iodo-polymer |
|---|---|---|
| 1 | 2.0 | 75:25 |
| 2 | 8.0 | 90:10 |
| 3 | 10.0 | 90:10 |

Silyl:iodo ratio measured by ¹H NMR Integrations

Example 3 showed that when a relatively volatile chlorosilane was used, improved silylation was achievable with extra equivalents of the chlorosilane.

### Example 4—Procedure for Silylation of Di-Polyethylene-Zinc with HPh₂SiCl

Example 3 was repeated, except that diphenylhydrogenchlorosilane was used instead of dimethylhydrogenchlorosilane. The results are shown below in Table 4.

TABLE 4

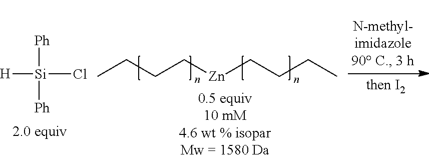

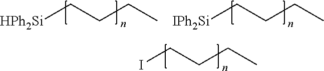

| Entry | Equiv. NMI | Silyl-polymer:Iodo-polymer |
|---|---|---|
| 1 | 2.0 | 80:20 |
| 2 | 0 | <5:95 |
| 3 | 1.0 | 20:80 |
| 4 | 0.1 | 5:95 |

Silyl:iodo ratio measured by ¹H NMR Integrations

Example 4 showed that complete silylation of the di-polyethylene-zinc was possible using NMI as an additive.

### Example 5—Procedure for Silylation of Di-Polyethylene-Zinc with H₂PhSiCl

Di-polyethylene-zinc and Isopar (Mw=1580 Da, 10 mM) were placed in a vial. The vial was heated at 120° C. until the contents became clear and homogeneous.

phenyl,dihydrogen,chlorosilane and an additive (NMI or blend of NMI with TMEDA) were added to the vial. The vial was heated for a period of time. I₂ was then added to quench unreacted di-polyethylene zinc. The resulting product was evaluated by ¹H NMR. The molar equivalents of chlorosilane, of additive, the time and temperature for heating, and conversion to product results are shown below in Table 5.

TABLE 5

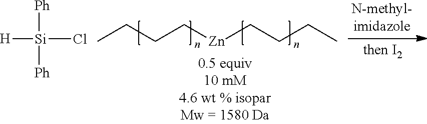

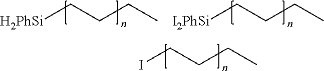

| | | Equiv. | | | Silyl-polymer: |
|---|---|---|---|---|---|
| Entry | Equiv. NMI | Chlorosilane | temp. (° C.) | time (h) | Iodo-polymer |
| 1 | 2.0 | 2.0 | 90 | 3 | >95:5 |
| 2 | 0.2 | 2.0 | 90 | 3 | 19:81 |
| 3 | 1.2 | 2.0 | 90 | 3 | >95:5 |
| 4 | 2.0 | 1.2 | 90 | 3 | >95:5 |
| 5 | 0.2 | 1.2 | 90 | 3 | 50:50 |
| | (0.55 equiv TMEDA) | | | | |
| 6 | 1.2 | 1.2 | 120 | 0.5 | >95:5 |

Silyl:iodo ratio measured by ¹H NMR Integrations

Example 5 showed that complete silylation with phenyl,dihydrogen,chlorosilane was observed with the conditions described in Entry 6. At least 1 equivalent of N-methylimidazole was capable of completing the hydrosilylation. A blend of NMI and another amine base was used as the additive for comparative purposes in Entry 5.

### Example 6

Di-polyethylene-zinc and Isopar (Mw=1080 Da, 10 mM) were placed in a vial. The vial was heated at 120° C. until the contents became clear and homogeneous. Phenyl,dihydrogen,chlorosilane and an additive were added to the vial. The vial was heated at 100° C. for 1 hour. Iodine (I_{D} was then added to quench unreacted di-polyethylene zinc.

The resulting product was evaluated by ¹H NMR. The additive and conversion to product results are shown below in Table 6.

TABLE 6

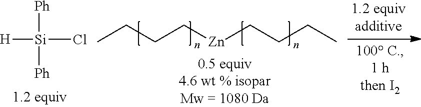

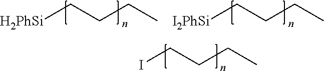

| Entry | Additive | Silyl-polymer:Iodo-polymer |
|---|---|---|
| 1 | TMAF | 51:49 |
| 2 | N-methyl-2-pyridone | 79:21 |
| 3 | DMPU | 89:11 |
| 4 | DMF | 53:47 |
| 5 | DMAP | >95:5 |
| 6 | Triethylamine | 36:64 |
| 7 | Pyridine N-oxide | >95:5 |
| 8 | none | 28:72 |

Silyl:iodo ratio measured by ¹H NMR Integrations

Example 6 showed that complete silylation was observed under the conditions tested using 4-dimethylaminopyridine, and pyridine-N-oxide as the additive. The example also showed that N-methyl pyridone and DMPU can also be used as the additive to promote silylation because as shown in Entry 2 and Entry 3, more silyl polymer formed than the comparative control (Entry 8) with no additive.

### Example 7

Example 3 was repeated using phenylhydrogendichlorosilane (HPhSiCl₂) instead of HMe₂SiCl and using 1.2 equivalents of N-methyl imidazole instead of 2 equivalents as the additive. The results are shown in Table 7, below.

TABLE 7

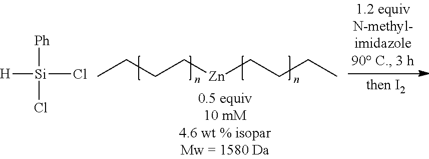

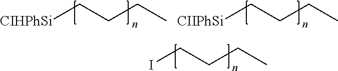

| Entry | Equiv. Chlorosilane | Silyl-polymer:Iodo-polymer |
|---|---|---|
| 1 | 0.6 | 65:35 |
| 2 | 1.2 | 95:<5 |

Silyl:iodo ratio measured by ¹H NMR Integrations

Example 7 showed that substitution occurred at only one of the two Si—Cl bonds, even when the amount of phenylhydrogendichlorosilane was reduced.

### Example 8

Di-polyethylene-zinc and Isopar (Mw=1205 Da, 10 mM) were placed in a vial. The vial was heated at 120° C. until the contents became clear and homogeneous. Dimethylhydrogeniodosilane and NMI were added to the vial. The vial was heated at 110° C. for 3 hours. Iodine (I₂) was then added to quench unreacted di-polyethylene zinc. The resulting product was evaluated by ¹H NMR. The molar equivalents of HMe₂Sil and conversion to product results are shown below in Table 8.

TABLE 8

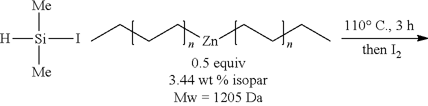

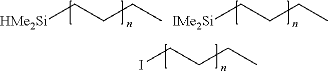

| Entry | Equiv. NMI | Silyl-polymer:Iodo-polymer |
|---|---|---|
| 1 | 0.0 | 15:85 |
| 2 | 1.2 | 95:<5 |

Silyl:iodo ratio measured by ¹H NMR Integrations

Example 8 showed that NMI also promoted silylation with halosilanes other than chlorosilanes (e.g., iodosilanes). In the absence of NMI, the iodosilane was not electrophilic enough to undergo complete reaction with the dipolyethylene-zinc under the conditions tested in this example.

### Example 9

Silylation of an ethylene/octene polymeryl zinc with phenyldihydrogenchlorosilane was performed as follows. In a glovebox, a 20 mL vial was charged with the copolymerylzinc (Mn=1940 Da, 30.66% octene, 3.10% polymer in Isopar™ E, 14.95 g, 0.117 mmol, 0.500 equiv). The mixture was stirred and heated to 110° C. until the mixture became clear and homogeneous. NMI (22.5 μL, 0.282 mmol, 1.20 equiv) was added, followed by chlorophenylsilane (37.6 μL, 0.282 mmol, 1.20 equiv). The mixture was stirred for 1 hour. A portion of the solution was removed and quenched with an excess of iodine for conversion analysis. The polymer solution was poured into an excess of methanol, which precipitated polymer. The polymer was isolated by filtration and was dried in a vacuum oven.

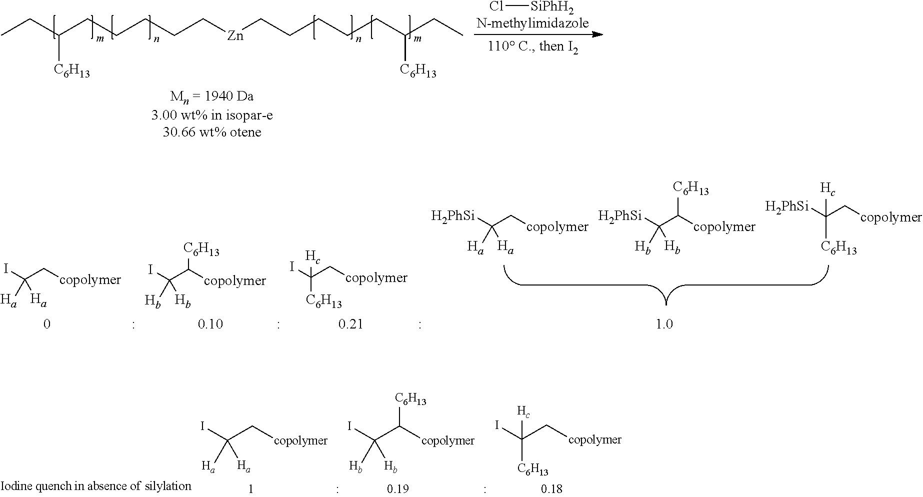

Example 9 showed that silylation with an ethylene/octene copolymeryl-zinc is possible using NMI.

### Example 10

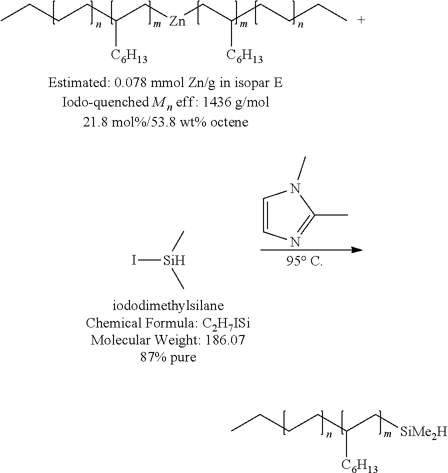

Example 10 is directed to the silylation of an ethylene/octene copolymeryl zinc with high octene content and using 1,2-dimethylimidazole as an alternative reagent to 1-methylimidazole. In a N₂ filled glovebox, a solution of (poly(ethylene-co-octene))₂Zn in isopar E was poured into a 2 L round bottom flask in a preheated heating block set to 95° C. The flask contained 600 g of polymerylzinc solution, or 22.69 mmol of polymerylzinc (0.5 equiv.). A 33 wt % stock solution of 1,2-dimethylimidazole was prepared in toluene and dried over molecular sieves.

To the reaction flask was added 31.4 g (10.46 g of neat compound, 108.9 mmol, 2.4 eq) of 1,2-dimethylimidazole solution, followed by 21.8 g (for 100% pure: 20.26 g, 108.9 mmol, 2.4 eq) of 87% pure iododimethylsilane by syringe. The reaction was stirred at 95° C. After 15.5 hours, an aliquot was removed from the flask and quenched with I₂.for conversion analysis. By ¹H-NMR, the integration of the dimethylsilyl peaks indicated approximately 94% conversion. Another 6.7 g (33.47 mmol, 0.74 equiv.) of iododimethylsilane and 13.1 g (45.43 mmol, 1.00 equiv.) of 1,2-dimethylimidazole solution was added the reaction and stirred at 95° C.

After an additional 5 hours, another aliquot was removed, quenched, and analyzed. ¹H-NMR spectrum analysis showed that the reaction was at approximately 97% conversion. Then, another 5.7 g (28.5 mmol, 0.63 equiv.) of iododimethylsilane and 10.7 g (37.11 mmol, 0.80 equiv.) of 1,2-dimethylimidazole solution was added to the reaction. The reaction was stirred at 95° C.

After a total of 24 hours of heating and stirring, another aliquot was removed and quenched, which showed zero detectable alkyliodide remaining. The reaction was deemed complete and cooled to room temperature overnight.

Then, the flask was removed from the glovebox and poured into 1 L of MeOH. The entire mixture was poured into a 2 L separatory funnel with hexane washings and the layers were allowed to separate. The bottom MeOH layer was drained and the isopar/hexane layer containing the desired product was washed twice with MeOH and twice more with water. The organic layer was then dried over sodium sulfate and decanted into a 1 L round bottom flask. The solvent was removed on a rotary evaporator at 40° C.

The concentrated product was then poured into a glass bottle and sparged with a high flow of nitrogen at 45° C. 47 g of the desired SiH-functionalized polymer was collected as an oil.

### Example 11

This example 11 shows a water washing method used to purify 850 g/mol Mn mono-SiH terminated polyethylene. 0.90 g of mono-SiH polyethylene prepared as described above was diluted to 10 wt % in toluene in a 100 mL round bottom flask containing a magnetic stir bar. The solution was heated by placing the flask in an aluminum block at a temperature of 85° C. The mono-SiH terminated polyethylene dissolved. Deionized water (6 g) was added and mixed for 5 minutes. Stirring was then stopped, and the aqueous phase (on bottom) was removed using a plastic pipette. Excellent separation was achieved. Both phases were clear, and the pH of wash water was alkaline.

The following process was performed 7 times at 85° C. Deionized water (4 g) was added and mixed for 5 minutes. The aqueous phase was removed. The resulting solution of toluene and mono-SiH terminated polyolefin was poured onto a Teflon™ sheet to dry overnight. The pH of the final water wash was on the slightly acidic side, indicating that the imidazole was successfully removed.

### Example 12—GPC Analysis

The silyl terminated polyolefin (polymer) samples were analyzed on a PolymerChar GPC-IR maintained at 160° C. The sample was eluted through 1×PLgel 20 um 50×7.5 mm guard column and 4×PLgel 20 um Mixed A LS 300×7.5 mm columns with 1,2,4-trichlorobenzene (TCB) stabilized by 300 ppm of butylated hydroxyl toluene (BHT) at a flowrate of 1 mL/min. The ˜16 mg of polymer sample was weighed out and diluted with 8 mL of TCB by the instrument. For molecular weight, a conventional calibration of polystyrene (PS) standards (Agilent PS-1 and PS-2) was used with apparent units adjusted to homo-polyethylene (PE) using known Mark-Houwink coefficients for PS and PE in TCB at this temperature. Decane was used as an internal flow marker and retention time was adjusted to this peak. For the comonomer incorporation, co-polymers of known composition were used to develop a calibration curve for incorporation.

### INDUSTRIAL APPLICABILITY

The above examples show that adding a nitrogen containing heterocycle facilitates functionalizing polymeryl-metal species with halosilanes, particularly halosilanes having at least one silicon bonded hydrogen per molecule. Different halosilanes (including organo hydrogen chlorosilanes) will react with different polymeryl-metal species.

### Definitions and Usage of Terms

All amounts, ratios, and percentages are by weight unless otherwise indicated by the context of the specification. The amounts of all starting materials in a composition total 100% by weight. The Brief Summary of the Invention and the Abstract are hereby incorporated by reference. The articles ‘a’, ‘an’, and ‘the’ each refer to one or more, unless otherwise indicated by the context of specification. The disclosure of ranges includes the range itself and also anything subsumed therein, as well as endpoints. For example, disclosure of a range of 1 to 20 includes not only the range of 1 to 20 including endpoints, but also 1, 2, 3, 4, 6, 10, and 20 individually, as well as any other number subsumed in the range. Furthermore, disclosure of a range of, for example, 1 to 20 includes the subsets of, for example, 1 to 3, 2 to 6, 10 to 20, and 2 to 10, as well as any other subset subsumed in the range. Similarly, the disclosure of Markush groups includes the entire group and also any individual members and subgroups subsumed therein. For example, disclosure of the Markush group a hydrogen atom, an alkyl group, an alkenyl group, or an aryl group, includes the member alkyl individually; the subgroup hydrogen, alkyl and aryl; the subgroup hydrogen and alkyl; and any other individual member and subgroup subsumed therein.

“Periodic Table of the Elements” refers to the Periodic Table of the Elements published in the CRC Handbook of Chemistry and Physics, 68^{th} Edition, by CRC Press, Inc., 1987. Any reference to a Group or Groups means the Group or Groups reflected in this Periodic Table of the Elements using the IUPAC system for numbering groups.

The term “comprising” and derivatives thereof means including and is not intended to exclude the presence of any additional component, starting material, step or procedure, whether or not the same is disclosed herein.

The term “hydrocarbyl” means groups containing only hydrogen and carbon atoms, including branched or unbranched, saturated or unsaturated, cyclic or noncyclic groups. Monovalent hydrocarbyl groups include alkyl, cycloalkyl, alkenyl, alkadienyl, cycloalkenyl, cycloalkadienyl, aryl, and alkynyl groups.

The following abbreviations are used throughout the specification.

TABLE X
Abbreviations.

| Abbreviation | Definition |
|---|---|
| ¹H NMR | ¹H NMR spectra may be recorded on a |
| | Bruker AV-400 spectrometer at ambient temperature. |
| | ¹H NMR chemical shifts in 1,1,2,2- |
| | tetrachloroethane-d2 as the solvent were referenced |
| | to 6.00 (1,1,2,2-tetrachloroethane-d1). |
| ° C. | Degrees Celsius |
| Et₂Zn | Diethyl zinc |
| HMe₂SiCl | Dimethylhydrogenchlorosilane |
| HMe₂SiEt | Dimethyl,hydrogen,ethyl silane |
| HPh₂SiCl | diphenylhydrogenchlorosilane |
| Da | Dalton |
| DMAP | 4-(dimethylamino)pyridine |
| DMF | N,N-dimethylformamide |
| DMPU | 1,3-dimethyl-3,4,5,6-tetrahydro-2-pyrimidinone |
| Et | ethyl |
| g | grams |
| GPC | Gel permeation chromatography |
| HMPA | hexamethylphosphoramide |
| Me | methyl |
| mg | milligrams |
| mM | Millimolar |
| mmol | millimoles |
| Mw | Weight average molecular weight as measured by the |
| | test method described above in Example 12 |
| NMI | N-methylimidazole |
| NMR | Nuclear magnetic resonance |
| RT | Room temperature of 20° C. to 25° C. |
| TASF | tris(dimethylamino)sulfonium difluorotrimethylsilicate |
| TMAF | Tetramethylammonium fluoride |
| TMEDA | Tetramethylenediamine |
| μL | microliters |
| Vi | Vinyl |
| ViMe₂SiCl | dimethylvinylchlorosilane |
| ViMe₂SiEt | Dimethyl,vinyl,ethyl silane |

### EMBODIMENTS OF THE INVENTION

In a first embodiment, a process for preparing a silyl-terminated polyolefin comprises:

optionally, forming a polymeryl-zinc before step 1) by a process comprising combining starting materials comprising

i) an olefin monomer,

ii) a catalyst, and

iii) a chain shuttling agent of formula R₂Zn, where each R is independently a hydrocarbyl group of 2 to 30 carbon atoms;

optionally iv) a solvent,

optionally vi) a scavenger,

optionally vii) an adjuvant, and

optionally viii) a polymerization aid;

optionally purifying A) the polymeryl-zinc before step 1);
1) combining starting materials comprising

A) a polymeryl-zinc;

B) a nitrogen containing heterocycle, and

C) a halosilane;

thereby forming a product comprising the silyl-terminated polyolefin;
optionally 2) washing the product with water; and
optionally 3) recovering the product.

In a second embodiment, in the process of the first embodiment, each R has 2 to 20 carbon atoms, and alternatively each R has 2 to 12 carbon atoms.

In a third embodiment, in the process of the first embodiment, R₂Zn is diethyl zinc.

In a fourth embodiment, in the process of any one of the preceding embodiments, A) the polymeryl-zinc comprises A1) di-polyethylene zinc, A2) polyethylene/octene zinc, or a mixture of A1) and A2).

In a fifth embodiment, in the process of any one of the preceding embodiments, B) the nitrogen containing heterocycle has a general formula selected from the group consisting of

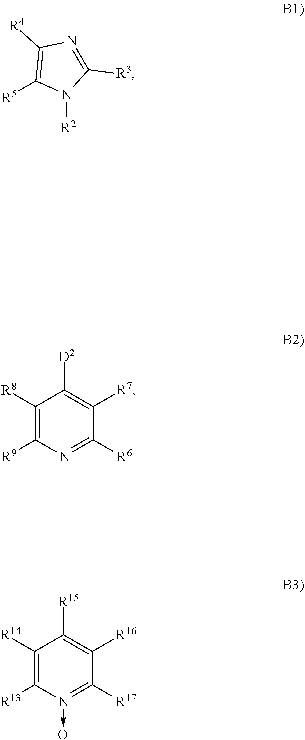

or and mixtures of two or more of B1), B2), and B3), where R² is a monovalent hydrocarbyl group, R³ is a hydrogen atom or a monovalent hydrocarbyl group, R⁴ is a hydrogen atom or a monovalent hydrocarbyl group, R⁵ is a hydrogen atom or a monovalent hydrocarbyl group, R⁶ is a hydrogen atom or a monovalent hydrocarbyl group, R⁷ is a hydrogen atom or a monovalent hydrocarbyl group, R⁸ is a hydrogen atom or a monovalent hydrocarbyl group, R⁹ is a hydrogen atom or a monovalent hydrocarbyl group, D² is an amino functional hydrocarbyl group or group of formula NR¹¹₂, where each R¹¹ is independently a monovalent hydrocarbyl group R¹³ is a hydrogen atom or a monovalent hydrocarbyl group, R¹⁴ is a hydrogen atom or a monovalent hydrocarbyl group, R¹⁵ is a hydrogen atom or a monovalent hydrocarbyl group, R¹⁶ is a hydrogen atom or a monovalent hydrocarbyl group, and R¹⁷ is a hydrogen atom or a monovalent hydrocarbyl group.

In a sixth embodiment, in the process of any one of the first through fourth embodiments, B) the nitrogen containing heterocycle is selected from the group consisting of: B4) NMI, B5) 4-(dimethylamino)pyridine, B6) pyridine N-oxide, B7) 1,2-dimethylimidazole, and mixtures of two or more of B4), B5), B6), and B7).

In a seventh embodiment, in the process of any one of the preceding embodiments, C) the halosilane has formula R¹ₐSiX₍₄₋ₐ₎, where each R¹ is independently selected from hydrogen and a monovalent hydrocarbyl group of 1 to 18 carbon atoms, each X is a halogen atom, and subscript a is 1 to 3.

In an eighth embodiment, in the process of the seventh embodiment, each R¹ is independently selected from hydrogen, alkyl, and aryl; X is chlorine or iodine; and subscript a is 1 or 2.

In a ninth embodiment, in the process of the eighth embodiment, at least one R¹ is hydrogen.

In a tenth embodiment, in the process of any one of the first through eighth embodiments, C) the halosilane is selected from the group consisting of C1) dimethylhydrogenchlorosilane, C2) dimethylvinylchlorosilane, C3) diphenylhydrogenchlorosilane, C4) phenyldihydrogenchlorosilane, C5) phenylhydrogendichlorosilane, C6) dimethylhydrogeniodosilane, and mixtures of two or more of C1), C2), C3), C4), C5), and C6).

In an eleventh embodiment, a process for preparing a hydrocarbyl functional silane comprises:

1) combining starting materials comprising

A) a chain shuttling agent of formula R₂Zn, where each R is independently a hydrocarbyl group of 2 to 30 carbon atoms;

B) a nitrogen containing heterocycle, and

C) a halosilane;

thereby forming a product comprising the hydrocarbyl functional silane.
optionally 2) washing the product with water; and
optionally 3) recovering the product.

In a twelfth embodiment, in the process of the eleventh embodiment, each R has 2 to 20 carbon atoms, and alternatively 2 to 12 carbon atoms.

In a thirteenth embodiment, in the process of the eleventh embodiment, R₂Zn is diethyl zinc.

In a fourteenth embodiment, in the process of any one of the eleventh through thirteenth embodiments, A) the polymeryl-zinc comprises A1) di-polyethylene zinc, A2) polyethylene/octene zinc, or a mixtures of A1) and A2).

In a fifteenth embodiment, in the process of any one of the eleventh through fourteenth embodiments, B) the nitrogen containing heterocycle has a general formula selected from the group consisting of

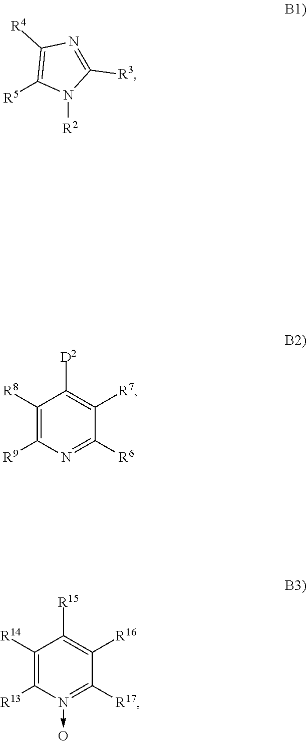

and mixtures of two or more of B1), B2), and B3), where R² is a monovalent hydrocarbyl group, R³ is a hydrogen atom or a monovalent hydrocarbyl group, R⁴ is a hydrogen atom or a monovalent hydrocarbyl group, R⁵ is a hydrogen atom or a monovalent hydrocarbyl group, R⁶ is a hydrogen atom or a monovalent hydrocarbyl group, R⁷ is a hydrogen atom or a monovalent hydrocarbyl group, R⁸ is a hydrogen atom or a monovalent hydrocarbyl group, R⁹ is a hydrogen atom or a monovalent hydrocarbyl group, D² is an amino functional hydrocarbyl group or group of formula NR¹¹₂, where each R¹¹ is independently a monovalent hydrocarbyl group, R¹³ is a hydrogen atom or a monovalent hydrocarbyl group, R¹⁴ is a hydrogen atom or a monovalent hydrocarbyl group, R¹⁵ is a hydrogen atom or a monovalent hydrocarbyl group, R¹⁶ is a hydrogen atom or a monovalent hydrocarbyl group, and R¹⁷ is a hydrogen atom or a monovalent hydrocarbyl group.

In a sixteenth embodiment, in the process of any one of the eleventh through fourteenth embodiments, B) the nitrogen containing heterocycle is selected from the group consisting of: B4) NMI, B5) 4-(dimethylamino)pyridine, B6) pyridine N-oxide, B7) 1,2-dimethylimidazole, and mixtures of two or more of B4), B5), B6), and B7).

In a seventeenth embodiment, in the process of any one of the eleventh through sixteenth embodiments, C) the halosilane has formula R¹ₐSiX₍₄₋ₐ₎, where each R¹ is independently selected from hydrogen and a monovalent hydrocarbyl group of 1 to 18 carbon atoms, each X is a halogen atom, and subscript a is 1 to 3.

In an eighteenth embodiment, in the process of the seventeenth embodiment, each R¹ is independently selected from hydrogen, alkyl, and aryl; X is chlorine or iodine; and subscript a is 1 or 2.

In a nineteenth embodiment, in the process of the eighteenth embodiment, at least one R¹ is hydrogen.

In a twentieth embodiment, in the process of any one of the eleventh through eighteenth embodiments, C) the halosilane is selected from the group consisting of C1) dimethylhydrogenchlorosilane, C2) dimethylvinylchlorosilane, C3) diphenylhydrogenchlorosilane, C4) phenyldihydrogenchlorosilane, C5) phenylhydrogendichlorosilane, C6) dimethylhydrogeniodosilane, and mixtures of two or more of C1), C2), C3), C4), C5), and C6).

What is claimed is:

1. A process for preparing a silyl-terminated polyolefin comprising:
1) combining starting materials comprising
A) a polymeryl-zinc;
B) a nitrogen containing heterocycle, and
C) a halosilane;
thereby forming a product comprising the silyl-terminated polyolefin.

2. The process of claim 1, further comprising: forming the polymeryl-metal before step 1) by a process comprising combining starting materials comprising
i) an olefin monomer,
ii) a catalyst, and
iii) a chain shuttling agent of formula R2Zn, where each R is independently a monovalent hydrocarbyl group of 2 to 12 carbon atoms.

3. The process of claim 2, where the starting materials further comprise one or more additional materials selected from: iv) a solvent, vi) a scavenger, vii) an adjuvant, and viii) a polymerization aid.

4. The process of claim 1, further comprising purifying A) the polymeryl-zinc before step 1).

5. The process of claim 1, where A) the polymeryl-zinc comprises A1) di-polyethylene zinc, A2) polyethylene/octene zinc, and a mixture of A1) and A2).

6. The process of claim 5, where the silyl terminated polyolefin has formula: 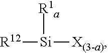
where R12 is hydrogen-terminated polyethylene, each R1 is independently selected from hydrogen and a monovalent hydrocarbyl group of 1 to 18 carbon atoms, each X is a halogen atom, and subscript a is 1 to 3.

7. A process for preparing a hydrocarbyl functional silane comprising:
1) combining starting materials comprising
A) a chain shuttling agent of formula R2Zn, where each R is independently a monovalent hydrocarbyl group of 2 to 12 carbon atoms;
B) a nitrogen containing heterocycle, and
C) a halosilane;
thereby forming a product comprising the hydrocarbyl functional silane.

8. The process of claim 7, where the starting materials further comprise D) a solvent.

9. The process of claim 7, where the hydrocarbyl functional silane has formula: 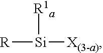
where each R is independently a monovalent hydrocarbyl group of 2 to 12 carbon atoms, each R1 is independently selected from hydrogen and a monovalent hydrocarbyl group of 1 to 18 carbon atoms, each X is a halogen atom, and subscript a is 1 to 3.

10. The process of claim 1, further comprising one or more additional steps selected from:
2) washing the product with water,
3) recovering the product.

11. The process of claim 1, where B) the nitrogen containing heterocycle has a general formula selected from: 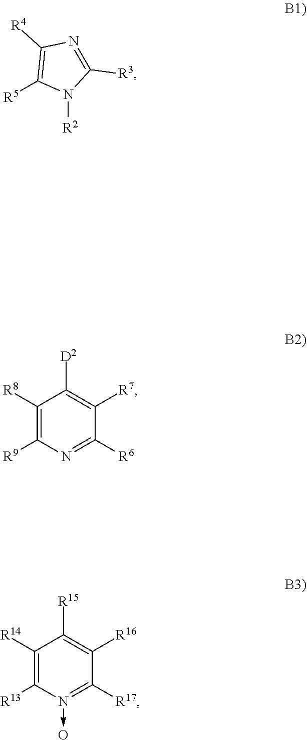
or two or more of B1), B2) and B3), where R2 is a monovalent hydrocarbyl group, R3 is a hydrogen atom or a monovalent hydrocarbyl group, R4 is a hydrogen atom or a monovalent hydrocarbyl group, R5 is a hydrogen atom or a monovalent hydrocarbyl group, R6 is a hydrogen atom or a monovalent hydrocarbyl group, R7 is a hydrogen atom or a monovalent hydrocarbyl group, R8 is a hydrogen atom or a monovalent hydrocarbyl group, R9 is a hydrogen atom or a monovalent hydrocarbyl group, and D2 is an amino functional hydrocarbyl group or group of formula —NR112, where each R11 is a monovalent hydrocarbyl group, R13 is a hydrogen atom or a monovalent hydrocarbyl group, R14 is a hydrogen atom or a monovalent hydrocarbyl group, R15 is a hydrogen atom or a monovalent hydrocarbyl group, R16 is a hydrogen atom or a monovalent hydrocarbyl group, and R17 is a hydrogen atom or a monovalent hydrocarbyl group.

12. The process of claim 1, where starting material B) is selected from the group consisting of:

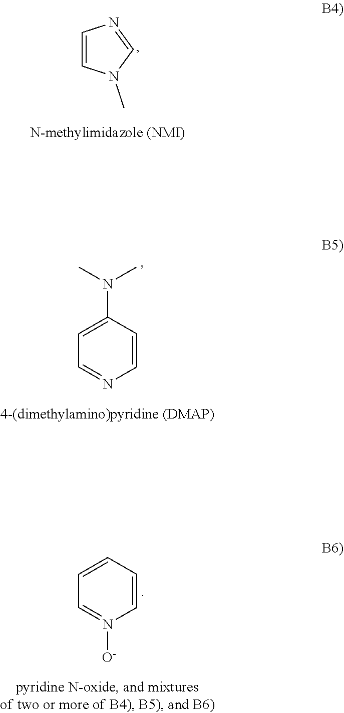

13. The process of claim 1, where C) the halosilane has formula R1aSiX(4-a), where each R1 is independently selected from hydrogen and a monovalent hydrocarbyl group of 1 to 18 carbon atoms, each X is a halogen atom, and subscript a is 1 to 3.

14. The process of claim 13, where each R1 is independently selected from hydrogen, alkyl, and aryl; X is chlorine or iodine; and subscript a is 1 or 2.

15. The process of claim 2, where R2Zn is diethyl zinc.
